(19) United States
(12) Patent Application Publication
(10) Pub. No.: US 2016/0245549 A1
(43) Pub. Date: Aug. 25, 2016

(54) LYONS FURNACE SYSTEM

(71) Applicant: Edward Earl Lyons, North Las Vegas, NV (US)

(72) Inventor: Edward Earl Lyons, North Las Vegas, NV (US)

(21) Appl. No.: 14/628,245

(22) Filed: Feb. 21, 2015

(51) Int. Cl. F24H 3/04; H05B 3/03; H05B 3/00

(52) U.S. Cl. CPC F24H 3/0411; H05B 3/0014; H05B 3/03

(57) ABSTRACT

The present invention is an electric furnace system powered by an onboard Alternating Current (AC) generator that has an Electric Drive Motor and Direct Current (DC) battery starter system to provide heat without usage of the utility grid.

### CROSS REFERENCE TO RELATED APPLICATIONS

U.S. Application No. 62/015,279 Filing Date: Jun. 20, 2014

### STATEMENT REGARDING RESEARCH OR DEVELOPMENT

n/a

### REFERENCE OF SEQUENCE LISTING COMPACT DISC APPENDIX

n/a

### BACKGROUND OF THE INVENTION

The present invention relates to the field of heating and cooling.

Currently standard furnaces do not operate when the power grid fails.

During seasonal storms power outages leave people without heat forcing them to abandon their homes.

Outside events in winter, use gas or diesel generators for heat and power in tents.

### BRIEF SUMMARY OF INVENTION

The present invention seeks to provide a solution to these problems by providing a furnace that power outages would not have any effect on its operations; although lights would be interrupted heat will remain constant. Also, external generators will not be necessary to provide heat in tents during winter events.

### BRIEF DESCRIPTION OF THE SEVERAL VIEWS OF THE DRAWINGS

FIG. 1 is a collection of labeled parts used in the construction of the invention. (1) Direct Drive Blower (3) Generator (5) Control relay board (7) Flywheel (9) Power convertor (11) Heat Coil (13) Transformer (15) Battery (17) Drive Motor (19) Starter (21) Safety Sensor

FIG. 2 is a side view of an example of the invention with the parts assembled in up flow form with corresponding numbers to FIG. 1.

### DETAILED DESCRIPTION OF THE INVENTION

The present invention is an electric furnace system that uses a Direct Current (DC) battery. The Direct Current battery powers a starter motor-mounted on a bracket on the lower side of the generator—that turns a flywheel (located on the shaft between the generator and drive motor). An Alternating Current (AC) generator (mounted to floor of the furnace) provides power for the electric furnace cycle. The Electric Drive motor has an internal groove system that interlocks on the shaft of the generator in order to turn it. The Heating Coil provides heat for the system located within the heat exchanger just above the Direct Drive Blower. The Direct Drive Blower (located in the center of the furnace beneath the Heater Coil) provides force to move the conditioned air into the desired space. A Power Converter (located beneath the battery) allows the battery to power the thermostat through the transformer when the system is not running it also, allows the generator to charge the battery while system runs. The Control Relay Board the brain of the system that is located on the front of the blower holds the relays and micro processors. The Safety Sensor (located near the Heater Coil) signals the blower when the air temperature is satisfactory.

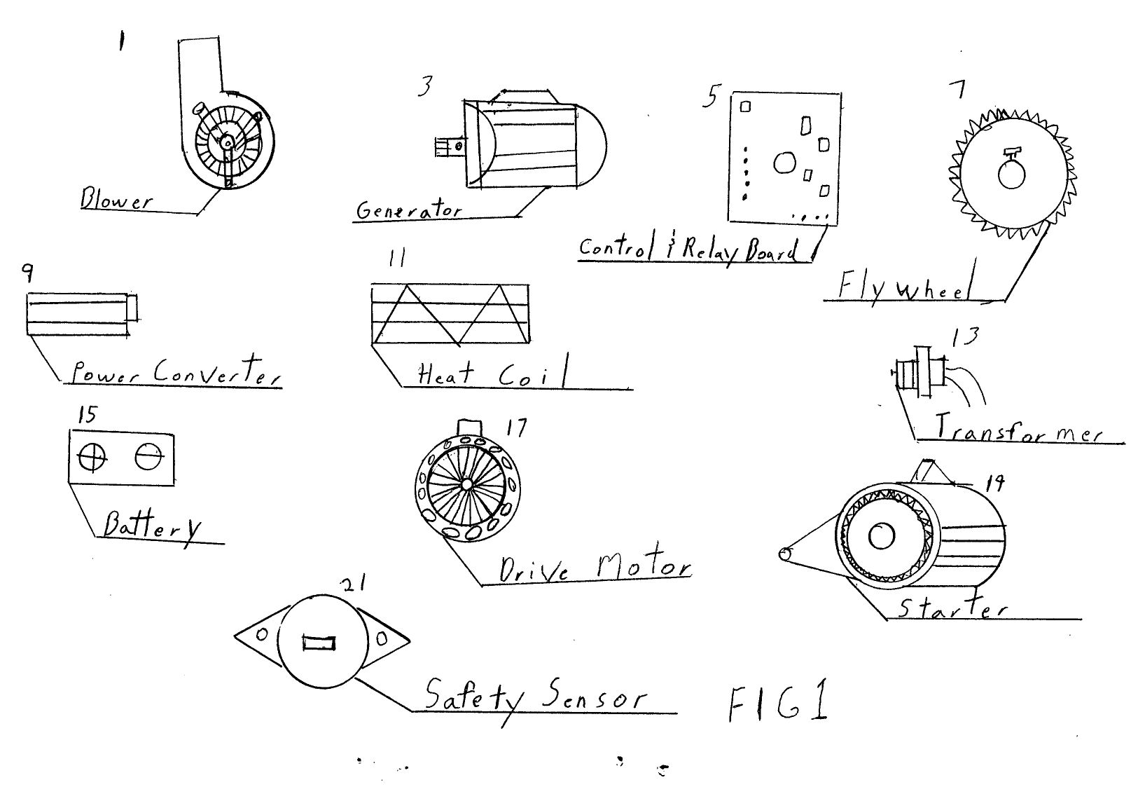

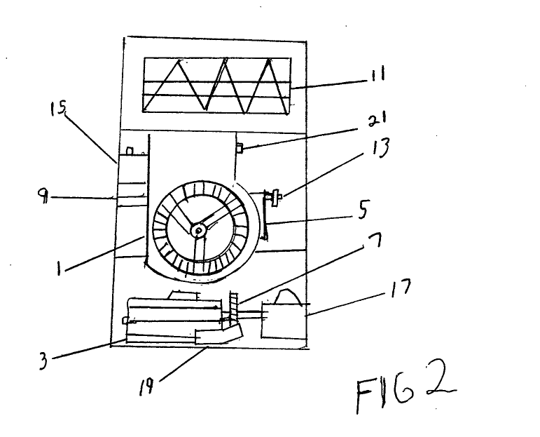

These parts and locations are depicted in FIGS. 1 and 2.

(Heat cycle)—First, the thermostat activates the Direct Current (DC) starter which turns the fly wheel powering the generator. Next, the relay engages the Drive Motor and Heater Coil disengaging the starter. When the limit is met, the Direct Drive Blower is engaged and operates until the thermostat is satisfied. Lastly, while the system is running, the generator recharges the battery through the converter.

(AC cycle)—First, the thermostat activates the Direct Current (DC) starter which turns the fly wheel powering the generator. Next, the relay engages the drive motor and disengages the starter. Then, the Direct Drive Blower and AC compressor are powered and run until thermostat is satisfied. Lastly, while the system is running the generator recharges the battery through the converter.

1: The present invention is an electric furnace system powered by an onboard Alternating Current (A. C.) generator.

2: The present invention has a Direct Current (D.C.) battery starter system.

3: The present invention uses a power converter to start the system and recharges the battery.
